(19) United States
(12) Patent Application Publication
(10) Pub. No.: US 2011/0308181 A1
(43) Pub. Date: Dec. 22, 2011

(54) BARRIER SHEET USEFUL FOR HOUSEWRAP

(76) Inventor: David Tony FREEMAN, Spartanburg, SC (US)

(21) Appl. No.: 12/820,234

(22) Filed: Jun. 22, 2010

(51) Int. Cl. E04B 1/66; E04C 2/20; D06M 15/70; B32B 5/18; B32B 27/12; D04H 13/00

(52) U.S. Cl. 52/309.4; 442/374; 442/367; 442/372; 442/375; 52/506.01

(57) ABSTRACT

A composite sheet useful as a housewrap is provided having a textile substrate, with a cellular, polymer layer coated on at least one side of the substrate, wherein the cellular, polymer layer is created by applying a foamed, latex coating and heating the latex to create a semi-rigid, cellular membrane, and a water repellant finish applied to the outer surface of the textile substrate or the polymer layer. The properties of the composite sheet may be further modified by calendering, to reduce the overall thickness of the sheet by 50% or more.

This invention is directed to a vapor permeable, liquid impermeable, composite sheet, useful as a housewrap, having a textile substrate and a cellular, polymer coating.

### BACKGROUND OF THE INVENTION

In the construction of buildings, it is common practice to install a barrier sheet between the sheathing and the exterior siding. The barrier sheet is designed to meet various performance criteria, for example, allowing the transmission of water vapor, to keep moisture from collecting within the wall assembly, while resisting the flow of air, as well as preventing water from passing from the exterior into the wall assembly. Additionally, the barrier sheet should possess sufficient physical strength to facilitate installation, without tearing, distorting or other change in structural integrity. The barrier sheet should not absorb water.

Historically, tar paper (asphalt impregnated felt) has been used as a barrier sheet in building construction. More recently, a variety of competing products based on synthetic fibers and films, or combinations thereof have entered the market. Commercial products include: AMOWRAP: woven polypropylene with a perforated coating; BARRICADE: woven polyethylene with a perforated coating; GREEN GUARD: cross-woven polyethylene; PINKWRAP: woven polypropylene with a perforated coating; R-WRAP: porous polyethylene film laminated to a scrim; TYPAR: spun-bonded polypropylene; and TYVEC: spun-bonded polyethylene.

Also, the following housewraps have been disclosed in the patent literature.

Gardner et al., U.S. Pat. No. 6,506,695 B2 disclose a breathable composite material useful as a housewrap. The composite comprises a nonwoven sheet having a thermoplastic film layer. The thermoplastic film layer comprises a fine particulate capable of promoting breathability, and the composite is passed through an embossing roll to create deformations, thereby further promoting breathability.

Lubker, II, U.S. Pat. No. 6,869,901 B2, discloses a three component housewrap, having a cross-woven or cross-laminate substrate, a polymer coating adjacent the substrate and a solid sheet adjacent either the substrate or the coating, wherein the substrate, coating and solid sheet are selected from a polyolefin, polyester, nylon or combinations thereof.

Porter, U.S. Pat. No. 7,148,160 B2, discloses a three-layer composite useful as a housewrap. The inner layer is a water vapor permeable, liquid impermeable, polymeric film. The film is applied by extrusion coating the polymer or by providing a film which is laminated to the substrate layer. The composite may have further finishes and treatments applied, including an acrylic latex.

Composite fabrics having various uses in protective clothing or cloths are also disclosed in the patent literature.

Schortmann, U.S. Pat. No. 5,204,165, discloses a composite material having two sheet layers bonded together. One of the layers is a wet-laid fabric made of a mixture of cellulose and polyester fibers. An acrylic latex binder is applied to bind the mixture of fibers together. A water-repellant treatment is applied to the wet-laid fabric. Finally, the first and second (wet-laid fabric) layers are bonded together by ultrasonic or thermal bonding, such a hot-calendering.

Lippman, U.S. Pat. No. 4,439,473 discloses a textile substrate coated with an open-cell polymer foam, such as an acrylic polymer, wherein the polymer foam has a hydrophobic compound, such as a fluoropolymer, incorporated therein. The composite is reported to be breathable, yet water repellant.

Rubin et al., U.S. Pat. No. 6,884,491 B2, disclose a fabric treated with a fluorochemical compound and backed with a polymeric film to provide a water repellant, stain resistant composite.

Wevers et al., US 2005/0106965 A1, disclose a multi-layer structure of a fabric and a polymer layer. The polymer may be foamed prior to application by heating the polymer to a melted or plasticized state and foaming the resulting gel. Alternatively, the polymer may be extruded on to the fabric, calendered and then foamed.

### SUMMARY OF THE INVENTION

The present invention is directed to a composite sheet having a textile substrate, with a cellular, polymer layer coated on at least one side of the substrate. The cellular, polymer layer is created by applying a foamed, latex coating and heating the latex to create a semi-rigid, cellular membrane. A water repellant finish is applied to the outer surface of (a) the textile substrate, on the side opposite from the polymer layer; or (b) the polymer layer. After both the polymer layer and the water repellant finish have been applied to the substrate, the composite sheet is then heated to effect drying and curing. After the cellular, polymer layer has been cured, the composite sheet may be compressed, such as by calendering, to reduce the thickness of the sheet by 50% or more.

The polymer layer may optionally contain 0.5 weight % or more of activated carbon particles, preferably 1 weight % or more, to adsorb pollutants from the atmosphere, such as volatile organic compounds (VOC's).

In an alternative embodiment of the invention, the composite sheet includes first and second cellular, polymer layers, on opposite sides of the textile substrate. The first cellular, polymer layer is created by applying a foamed latex coating and heating the latex to create a semi-rigid, cellular membrane. A water repellant finish is applied to the outer surface of the first, cellular polymer layer. Another layer of a foamed latex coating is applied to the textile substrate, on the opposite side of the substrate from the first polymer layer. The composite sheet is heated to effect drying and curing. After the first and second cellular, polymer layers have been cured, the composite sheet may be compressed, such as by calendering, to reduce the thickness of the sheet by 50% or more.

The composite sheet is characterized by: (i) a minimum MVTR of 50 g/m²/24 hrs. at 50% relative humidity and 23° C.; and (ii) a minimum Hydrostatic Head of 35 cm. Further, the substrate and cellular polymer layer can be selected to provide a composite sheet incorporating one or more of the following features: a minimum Trapezoidal Tear Strength of 9 lbs. in the machine direction (MD) and 4.5 lbs. in the transverse direction (TD); and a minimum Tensile Strength of 18 lbs. (MD) and 6 lbs. (TD). Additionally, the composite sheet can be manufactured to provide reduced air permeability, in particular the sheet may be provided with an air permeability of 300 sec/100 ml or less, where the higher the value (seconds)—the lower the air permeability.

Also included within the scope of the present invention is a building incorporating the composite sheet. The composite sheet is installed to cover all or a portion of the outer wall assembly, that is, the portion of the wall assembly that defines the outside of the building. The wall assembly may include an appropriate sheathing, as is known in the art, such as plywood, oriented strand board (OSB), gypsum board, fiberboard and rigid foam panels, installed prior to the wall assembly being covered with the composite sheet. The composite sheet is installed with the water repellant finish side facing outward, that is, away from the interior. Finally, an exterior siding is installed to cover the composite sheet. By way of example, the exterior siding may be wood siding, brick, stone, aluminum siding, vinyl siding, shakes, shingles or stucco. Thus, the building comprises the composite sheet of the present invention, sandwiched between the outer wall assembly and the exterior siding. Additionally, the composite sheet of the present invention may be employed as a barrier between the roof structure, typically plywood over rafters, and the exterior roofing material, typically shingles, shakes, slate or tiles.

The composite sheet made according to the present invention is economical to manufacture and meets the water vapor transmission, liquid water barrier and physical strength specifications required for application as a housewrap. Further, the cellular, polymer layer (or layers) contributes to insulating the building. Other advantages of the composite sheet, which may be found in one or more of the embodiments of the present invention, include minimal environmental impact, due to the compatibility of invention with substrates containing recycled material, resistance to yellowing by ultraviolet light and resistance to mildew growth.

### BRIEF DESCRIPTION OF THE DRAWINGS

FIG. 1 is a drawing of building, with a cutaway view showing the wall assembly, housewrap and exterior siding.

FIG. 2 is a side view of the composite sheet of the present invention.

FIG. 3 is a side view of an alternative embodiment of the composite sheet of the present invention, having first and second cellular, polymer layers.

### DETAILED DESCRIPTION OF THE INVENTION

Without intending to limit the scope of the invention, the preferred embodiments and features are hereinafter set forth. Unless otherwise indicated: all parts and percentages are by weight and conditions are ambient, i.e. one atmosphere of pressure, 25° C. and 50% relative humidity; aliphatic hydrocarbons and radicals thereof are from one to twelve carbon atoms in length; averages are based on the number average; and mean particle size is the mean volume diameter of the distribution as measured by laser light diffraction. The term “copolymer” is used in its broad sense to include polymer containing two or more different monomer units, such as terpolymers. Unless otherwise indicated, the cited test methods refer to the methods current in the year 2008.

All of the United States patents cited in the specification are hereby incorporated by reference.

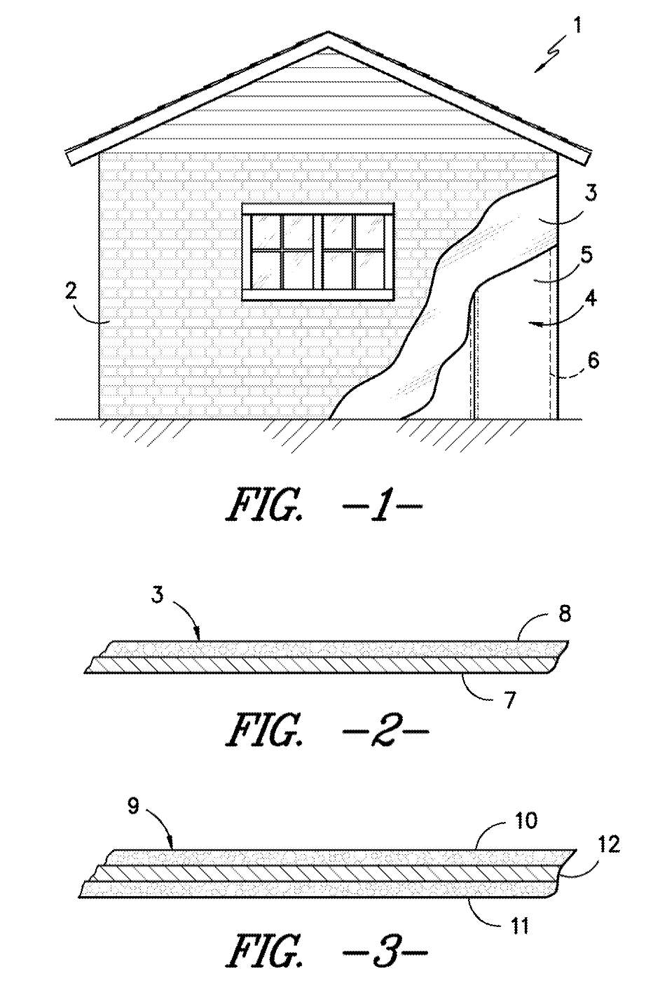

FIG. 1 shows building 1 with brick exterior siding 2. The brick is cutaway to show a composite sheet 3 installed as a housewrap over wall assembly 4, which includes plywood sheathing 5 and studs 6 (phantom lines). Composite sheet 3 may be held in place during installation by an appropriate fastening system, as is known in the art, such as by slap stapling, tacking, gluing with compatible adhesive or nailing, engaging plywood sheathing 5 or studs 6, as appropriate.

A magnified, side view of composite sheet 3 is shown in FIG. 2. Composite sheet 3 has substrate 7 and cellular, polymer layer 8. In the embodiment shown in FIG. 2, polymer layer 8 is substantially on one side of substrate 7. Substrate 7 may be a textile fabric. Textile fabrics useful in the present invention may be woven, knitted or nonwoven planar textile structures. The textile fabric may be constructed of staple or monofilament fibers, or spun yarn or multifilament yarn. A wide variety of natural and synthetic fiber substrates may be employed. By way of example, the fiber substrate may be selected from polyamide fibers, including nylon, such as nylon 6 and nylon 6,6, and aramid fibers; polyester fibers, such as polyethylene terephthalate (PET); polyolefin fibers, such as polypropylene and polyethylene, acrylic fibers, polyurethane fibers, cellulosic fibers, such as cotton, rayon and acetate; silk and wool fibers, and high modulus inorganic fibers, such as glass, quarts and ceramic fibers. Recycled fibers, such as recycled polyester, may be employed.

Fibers that absorb less than 5 wt. % water, preferably less than 2 wt. % water, may be employed to minimize moisture retention by composite sheet 3. Fibers of polyester, glass (fiberglass) and polyolefins, or combinations thereof are believed to be particularly useful.

By way of example, substrate 7 may be a needle-punched or spun-bonded fabric, optionally with laid in yarns running the length of the substrate, and a binder for stability. Needle-punched polyester fabric with laid in fiberglass yarns that are useful in the present invention are available from Freudenberg Nonwovens, Texbond Division, Macon, Ga., USA.

In its uncoated state, substrate 7 is not intended to be a barrier to water, that is, substrate 7 has a Hydrostatic Head of less than 10 cm.

Substrate 7 is selected so that the composite sheet of the present invention will meet minimum Trapezoidal Tear Strength, Tensile Strength and Burst Strength criteria, as desired, for particular applications. Additionally, substrate 7 should have sufficient coverage to support the application of the foamed polymer latex, during the manufacturing process, as is hereinafter described. Those skilled in art may select from a variety of textile fabric construction and weight combinations to accomplish the objectives of the invention. By way of example, substrate 7 may be a textile fabric ranging in weight from 0.5 to 10 oz/yd², in particular from 2 to 8 oz/yd², more particularly from 4 to 7 oz/yd².

As shown in FIG. 2, polymer layer 8 is coated on one side of substrate 7 of composite sheet 3 and has a cellular structure to allow water vapor to transfer from one side of the sheet to the other. Polymers that are particularly useful in the present invention are those that can be formulated as aqueous latices. By way of example, suitable polymers include acrylic polymers and polyurethanes.

Acrylic polymers useful in the present invention are polymers of acrylic acid, methacrylic acid and maleic anhydride (“acid functionalized vinyl monomers”), and copolymers of such acid functionalized vinyl monomers, or mixtures thereof, with other vinyl or vinylidene containing monomers, in particular C₁₋₁₂ esters of acrylic acid, methacrylic acid and maleic anhydride (particularly C₁₋₄ esters), styrene and styrene derivatives, such as alkylated styrenes and acrylonitrile and alkylacrylonitriles. Good results may be achieved using an acrylic polymer having a T_{g} of from −10° C. to 10° C.

Polyurethanes that are capable of forming aqueous latices may be employed. The techniques for manufacturing polyurethane latices are known to those skilled in art. Examples of polyurethane latices may be found in Tabor et al., U.S. Pat. No. 6,720,385 B2 and the references cited therein.

The polymer formulation may also contain a cross-linking agent, so that upon curing the cellular, polymer layer exhibits additional structural stability and resistance to swelling and loss of integrity in the presence of water. Preferably, the polymer formulation does not contain formaldehyde.

The polymer latex formulation may be provided as a range of concentrations, measured as the weight % polymer solids in the formulation. By way of example, the weight % of polymer solids may range from 30 to 70 weight %, alternatively 40 to 60 weight %, of the latex formulation.

The polymer latex formulation may contain additional additives to improve the performance of the composite sheet. Useful additives include fillers and pigments, such as clay, TiO₂ and opacifiers provided in an amount sufficient to render the composite opaque, plasticizers, antimicrobial agents, flame retardants, such as decabromodiphenyl oxide and antimony trioxide, and additives that modify the cell structure and performance of the foam.

In one embodiment of the invention, the polymer latex formulation contains carbon black particles or activated carbon particles, for example in powdered or granular form, which can adsorb volatile compounds, from the ambient air, such as VOC's and other pollutants. For example, activated carbon powder or granules may be dispersed in the polymer latex formulation at a concentration of greater than 0.1 weight %, particularly from 0.2 to 4 weight %, and more particularly from 0.5 to 2 weight %, based on the weight of the latex formulation.

The polymer latex is aerated to create a foam, prior to application to the substrate. Accordingly, a suitable foaming agent may be added to the formulation prior to aeration, to create a uniform, stable foam. The polymer latex is aerated to create a foam having a density of from 0.25 to 0.45 g/cm³, in particular from 0.28 to 0.38 g/cm³. An example of equipment useful for aerating the polymer latex is the Ease-E-Foamer from Ease, Inc.

The foamed polymer latex is applied to one side of the substrate to achieve a uniform coating. By way of example, the coating may be applied to the top surface of the substrate as the substrate travels horizontally past a floating knife, knife-over-roll, reverse roll, or knife-over-bed. In one embodiment of the invention, the coating is applied to achieve an add-on in the composite sheet, based on dried solids, of from 1 to 8 oz/yd², in particular from 2 to 6 oz/yd².

The substrate having the foamed polymer coating is then dried. The coated substrate may be dried in a gas-fired, forced air oven, or comparable production drier. In one embodiment of the invention, the coating is not dried completely, that is, a slight amount of moisture is left in the coating, whereby the temperature of the coating remains sufficiently low so that a cross-linking agent present in the polymer does not fully react. Sufficient moisture is removed from the coating in the drier, however, so that the coating is not tacky and does not adhere to the processing equipment. Good results have been achieved when the moisture content remaining in the coating, after the coated substrate passes through the drier, is from 2 to 9 weight %, in particular, from 4 to 7 weight %.

A water repellant finish is applied to at least one side of the coated substrate, after the coated substrate is passed through the drier to remove all or substantially all of the moisture from the coating. In one embodiment, the water repellant finish is applied to the substrate on the side opposite the polymer coated side.

The water repellant finish is selected and its application is tailored to meet the minimum MVTR and Hydrostatic Head performance requirements of the final product. Various combinations of water repellant finishes and add-on amount may be employed. By way of example, the water repellant finish may represent from 0.025 to 1 weight % of the final product, particularly from 0.05 to 0.5 weight %.

Suitable water repellant finishes include fluorocarbons and fluoropolymers, as well as their derivatives, polysiloxanes, high molecular weight waxes, polyethylene, and combinations thereof. Curable water repellant finishes may be employed. Particularly useful are water repellant finishes that can be formulated and applied in the form of an aqueous dispersion. The water repellant finish may contain additives, such as an antimicrobial agent. The water repellant finish may be applied to the coated substrate by spraying, padding, knife coating, foaming or kiss roll.

After the water repellant finish has been applied, the coated substrate is then dried. A gas-fired, forced air convection drier may be employed. The temperature and retention time is sufficient to remove the water from the composite sheet. By way of example, the composite sheet may be heated to a temperature of 300° F. or more, in particular to a temperature of 315° F. or more. Passing the material through an oven having a temperature of 325° F. for 45 to 60 seconds has been found to achieve complete drying.

In the embodiment of the invention in which a slight amount of moisture is left in the polymer coating to delay curing, the residual moisture is removed in the second drying step. Without being bound to a particular theory, it is believed that when the water repellant finish is applied to the side of the substrate opposite the coating, the finish penetrates into the substrate and forms a film on the backside of the coating. When the residual moisture is driven from the polymer coating, and the curing reaction is complete, the water repellant finish becomes fixed to the polymer. Furthermore, it is believed that the polymer coating penetrates into the interstices of the substrate, to firmly bind the coating to the substrate.

The dried composite sheet is then compressed to reduce the thickness, which increases the resistance of the composite sheet to penetration by liquid water and creates a smooth finish, which makes the product more durable and easier to install. Compression of the composite sheet has the effect of altering the cellular structure of the polymer layer. Nevertheless, the interstices remaining in the polymer layer are sufficient to meet the Moisture Vapor Transmission Rate requirements to serve as a housewrap. One method of compressing the composite sheet is by calendering, for example between a rubber roller and stainless steel roller, using unheated rollers. In various embodiments of the invention, the thickness of the dried and cured composite sheet is reduced by at least 50%, at least 75% and at least 80%. By way of example, composite sheets made according to the disclosure herein having a final thickness of 17 to 25 mils (thousands of an inch) have been found to meet the performance requirements of a minimum MVTR of 50 g/m²/24 hrs and a minimum Hydrostatic Head of 35 cm.

Referring to FIG. 3, an alternative embodiment of the invention is shown having composite sheet 9 and first and second cellular polymer layers 9 and 10, respectively, on opposite sides of substrate 12. The second cellular polymer layer may be created on the opposite side of the substrate, after the first polymer layer has been dried, according to the parameters described herein with respect to the first polymer layer. The first and second polymer layers may have the same or different chemical composition, formulation, density, additives and add-on weight. The water repellant finish may be applied to the outer surface of the first, cellular polymer layer, either before of after the second foamed polymer latex is applied to the substrate. In one embodiment of the invention, the second polymer latex coating and the water repellant finish may be dried simultaneously in the a single pass through the drier. The dried and cured composite sheet having first and second polymer layers is then calendered and set forth above with regard to the embodiment of the invention having a single polymer layer, with the exception that the final thickness of the product may have a final thickness of from 24 to 36 mils (thousands of an inch), in particular, a final thickness of from 24 to 30 mils.

The composite sheet of the present invention may be provided with various combinations of substrate construction and cellular, polymer layer selection and add-on weight, water repellant finish and compression, to achieve the performance criteria of a housewrap. By way of example, the overall weight of the composite sheet may range from 1.5 to 18 oz/yd², in particular, from 5 to 15 oz/yd², more particularly from 7 to 13 oz/yd².

### Test Methods and Properties of the Composite Sheet of the Present Invention

The following test methods are used in conjunction with the performance of the composite sheet of the present invention.

Moisture Vapor Transmission Rate (MVTR) is the measure of water vapor transmission through the sheet. It is determined by ASTM Test Method E 96, Standard Test Methods for Water Vapor Transmission of Materials, and is measured at 50% relative humidity and 23° C. Results are reported in g/m²/24 hrs. The composite sheet has a minimum MVTR of 50 g/m²/24 hrs, preferably a minimum of 75 g/m²/24 hrs.

Hydrostatic Head is the measure of the resistance of the sheet to penetration by liquid water under a static pressure. It is determined by AATCC 127, Hydrostatic Pressure Resistance. Results are reported in centimeters. The composite sheet has a minimum Hydrostatic Head of 35 cm, preferably a minimum of 50 cm.

Air Permeability is the measure of a sheet's resistance air flow, when a pressure differential is applied. It is determined according to test method TAPPI T-460, by measuring the number of seconds it takes for 100 ml of air to pass through the sheet, under standard conditions. Results are reported in sec/100 ml, where the higher the number (seconds)—the greater the resistance to air penetration. The composite sheet may be provided with a minimum Air Permeability of 100 sec/100 ml, preferably a minimum of 300 sec/100 ml, most preferably 1,000 sec/100 ml.

Trapezoidal Tear Strength is the measure of the resistance of a sheet to a continued tear. It is determined by ASTM Test Method D 1117. Results are reported in pounds. The composite sheet may be provided with a minimum Trapezoidal Tear Strength of 9 lbs. (MD) and 4.5 lbs. (TD).

Tensile Strength is the measure of the resistance of a sheet to failure when tensile stress is applied. It is determined by ASTM D 882. Results are reported in pounds. The composite sheet may be provided with a minimum Tensile Strength of 18 lbs. (MD) and 6 lbs. (TD).

The composite sheet of the present invention has been found to pass the Mildew and Rot Resistance of Textiles Test III (agar without nutrient) of AATCC-30, i.e. the composite exhibited no mildew growth.

### Example 1

A polyester nonwoven fabric, with laid in fiberglass yarns, product name Texbond® from Freudenberg Texbond, Macon, Ga., weighing 5.6 oz/yd² (190 g/m²) was used as the substrate.

An acrylic latex, product name SV-R34 from Para-Chem, Simpsonville, S.C., having a solids content of 48%, decabromodiphenyl oxide and antimony trioxide flame retardants, an opacifier, an antimicrobial agent and a plasticizer. No formaldehyde was included in the formulation. The latex was blended with granular, activated carbon (1% of latex formulation) and a foaming agent. The acrylic latex was aerated to create a foam, having a density of 0.32 g/cm³ and the substrate was coated with the foamed latex using a floating knife to achieve an add-on of 2.6 oz/yd², based on the polymer solids.

The coated substrate was passed through a gas-fired, forced air drier having a temperature of 350° F. for approximately 45-60 seconds. The moisture content of the polymer layer after drying was 6 weight %.

A fluorocarbon water repellant (Grande 101 2200 from Omnova Solutions, Inc.), in the form of an aqueous dispersion, was applied by spraying to the substrate, on the opposite side of the substrate from the polymer coating, to achieve an add-on of 0.1 weight % in the final product.

The sheet was passed through a gas-fired, forced air drier, to remove the residual moisture from the product and heat the sheet to a temperature of 325° F. The sheet was then calendered between a rubber roller and a stainless steel roller (unheated), to reduce the thickness from about 125 mils to 19 mils. The opaque, composite sheet weighed 8.2 oz/yd². The resulting composite sheet was tested and found to have the following properties, shown in Table 1.

TABLE 1

| Test | Composite Sheet of Ex. 1 |
|---|---|
| MVTR | 65 g/m²/24 hrs |
| Hydrostatic Head | 50 cm |
| Air Permeability | 1,200 sec/100 ml |
| Trapezoidal Tear Strength | 12 lbs. (MD)/6 lbs. (TD) |
| Tensile Strength | 23 lbs. (MD)/9 lbs. (TD) |

The invention may be further understood by reference to the following claims.

What I claim is:

1. A composite sheet comprising
(a) a textile substrate having a first and second side;
(b) a polymer layer coated on the first side of the textile substrate, whereby the polymer is applied to the textile substrate as a foamed latex coating and dried to create a cellular structure; and
(c) a water repellant finish applied to one of (i) the polymer foam layer or (ii) the second side of the textile substrate; and
(d) wherein the sheet has (i) a minimum MVTR of 50 g/m²/24 hrs; and (ii) a minimum Hydrostatic Head of 35 cm.

2. The composite sheet of claim 1, wherein the sheet is compressed after the polymer foam layer has been dried to reduce the thickness of the sheet by 50% or more.

3. The composite sheet of claim 2, wherein the polymer is applied to the textile substrate as a foamed latex having a density of from 0.25 to 0.45 g/cm³.

4. The composite sheet of claim 2, wherein the polymer is an acrylic polymer.

5. The composite sheet of claim 2, wherein the polymer is applied to the textile substrate as a foamed latex and the latex comprises from 0.2 to 4 weight % of activated charcoal particles dispersed therein.

6. The composite sheet of claim 1, wherein the textile substrate is a nonwoven fabric having laid-in fiberglass yarns in at least one direction.

7. The composite sheet of claim 6, wherein the textile substrate has (i) a minimum trapezoidal tear strength of 9 lbs. (MD) and 4.5 lbs. (TD) and a minimum tensile strength of 18 lbs. (MD) and 6 lbs. (TD).

8. The composite sheet of claim 1, wherein a second polymer foam layer is coated on the second side of the textile substrate, whereby the second polymer is applied to the textile substrate as a foamed latex coating and dried to create a cellular structure, and the water repellant finish is applied to a polymer layer on one of the first or second sides of the textile substrate.

9. The composite sheet of claim 8, wherein the sheet is compressed after the first and second polymer layers have been dried to reduce the thickness of the sheet by 50% or more.

10. The composite sheet of claim 9, wherein the first and second polymer layers are acrylic polymers, and wherein the first and second polymer layers are applied to the textile substrate as a foamed latex and at least one of the foamed latices comprises from 0.2 to 4 weight % of activated charcoal particles dispersed therein.

11. A building having a plurality of outer walls, covered with sheathing and exterior siding, comprising a composite sheet installed between the sheathing and the exterior siding, wherein the composite sheet comprises:
(a) a textile substrate having a first and second side;
(b) a polymer layer coated on the first side of the textile substrate, whereby the polymer is applied to the textile substrate as a foamed latex coating and dried to create a cellular structure; and
(c) a water repellant finish applied to one of (i) the polymer foam layer or (ii) the second side of the textile substrate; and
(d) wherein the sheet has (i) a minimum MVTR of 50 g/m²/24 hrs; and (ii) a minimum Hydrostatic Head of 35 cm.

12. The building of claim 11, wherein the composite sheet is compressed after the polymer foam layer has been dried to reduce the thickness of the sheet by 50% or more.

13. The building of claim 12, wherein the polymer is applied to the textile substrate as a foamed latex having a density of from 0.25 to 0.45 g/cm³.

14. The building of claim 12, wherein the polymer is an acrylic polymer.

15. The building of claim 12, wherein the polymer is applied to the textile substrate as a foamed latex and the latex comprises from 0.2 to 4 weight % of activated charcoal particles dispersed therein.

16. The building of claim 11, wherein the textile substrate is a nonwoven fabric having laid-in fiberglass yarns in at least one direction.

17. The building of claim 16, wherein the textile substrate has (i) a minimum trapezoidal tear strength of 9 lbs. (MD) and 4.5 lbs. (TD) and a minimum tensile strength of 18 lbs. (MD) and 6 lbs. (TD).

18. The building of claim 11, wherein a second polymer foam layer is coated on the second side of the textile substrate, whereby the second polymer is applied to the textile substrate as a foamed latex coating and dried to create a cellular structure, and the water repellant finish is applied to a polymer layer on one of the first or second sides of the textile substrate.

19. The building of claim 18, wherein the composite sheet is compressed after the first and second polymer layers have been dried to reduce the thickness of the sheet by 50% or more.

20. The building of claim 19, wherein the first and second polymer layers are acrylic polymers, and wherein the first and second polymer layers are applied to the textile substrate as a foamed latex and at least one of the foamed latices comprises from 0.2 to 4 weight % of activated charcoal particles dispersed therein.
